(19) United States
(12) Patent Application Publication
(10) Pub. No.: US 2024/0253115 A1
(43) Pub. Date: Aug. 1, 2024

(54) METHODS OF MAKING CEMENTED CARBIDE POWDERS FOR ADDITIVE MANUFACTURING

(71) Applicant: Kennametal Inc., Latrobe, PA (US)

(72) Inventors: Zhuqing Wang, Greensburg, PA (US); Paul D. Prichard, Greensburg, PA (US); Hadi Miyanaji, Murrysville, PA (US)

(21) Appl. No.: 18/583,538

(22) Filed: Feb. 21, 2024

Related U.S. Application Data
(62) Division of application No. 18/102,448, filed on Jan. 27, 2023.

(51) Int. Cl. B22F 1/065; B22F 3/15; B22F 9/02; B22F 9/04; B22F 10/14

(52) U.S. Cl. CPC B22F 1/065; B22F 3/15; B22F 9/026; B22F 9/04; B22F 10/14; B22F 2301/15; B22F 2302/10; B22F 2304/10

(57) ABSTRACT

Sintered cemented carbide powder compositions for use in the production of various articles by additive manufacturing are described. The individual particles of the powder compositions comprise metal carbide particles sintered together with a metallic binder. The sintered cemented carbide particles comprise a monomodal particle size distribution in which the sintered cemented carbide particles have a D50 of greater than 12 μm and a D10 of greater than 5 μm. The metallic binder may be present in an amount of from 9 to 11 weight percent based on total weight of the sintered cemented carbide particles. Sintered cemented carbide bodies comprising the described sintered cemented carbide powder compositions are also described. Methods of making the sintered cemented carbide powder compositions, and methods of making the sintered cemented carbide bodies are also described.

### CROSS-REFERENCE TO RELATED APPLICATION

This application is a divisional of U.S. patent application Ser. No. 18/102,448 filed Jan. 27, 2023, which is incorporated herein by reference.

### FIELD OF THE INVENTION

The present invention relates to sintered cemented carbide powder compositions used in additive manufacturing and sintered cemented carbide bodies additively manufactured with the sintered cemented carbide powder compositions.

### BACKGROUND INFORMATION

Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process. Most importantly, additive manufacturing enables significant freedom in article design. Articles having highly complex shapes can be produced without significant expense allowing the development and evaluation of a series of article designs prior to final design selection.

### SUMMARY OF THE INVENTION

Sintered cemented carbide powder compositions are provided for use in the production of various articles by additive manufacturing. The individual particles of the powder compositions comprise metal carbide particles sintered together with a metallic binder. The sintered cemented carbide particles comprise a monomodal particle size distribution in which the sintered cemented carbide particles have a D50 of greater than 12 μm and a D10 of greater than 5 μm. The metallic binder may be present in an amount of from 9 to 11 weight percent based on total weight of the sintered cemented carbide particles. Methods of making the sintered cemented carbide powder compositions, and methods of making the sintered cemented carbide bodies are also provided.

Disclosed herein is a method of making a powder composition for binder jet printing comprising milling tungsten carbide particles, a metallic binder, a polymeric binder, and a solvent to form a slurry; spray drying the slurry to form a powder; sintering the powder; milling and sieving the powder; and sintering the powder in a partial liquid state to form the powder composition, wherein the powder composition comprises cemented carbide particles having a D50 of greater than 12 μm, a D10 of greater than 5 μm, and an apparent density of from 3.0 g/cm³ to 6.0 g/cm³ and comprising 9 to 11 weight percent of a metallic binder based on total weight of the cemented carbide particles.

### BRIEF DESCRIPTION OF THE DRAWINGS

FIG. 1 is a scanning electron microscopy (SEM) image of C1 cross sections.

FIG. 2 is an SEM of C2 cross sections.

### DETAILED DESCRIPTION

The invention disclosed herein is directed to powder compositions for additive manufacturing comprising sintered cemented carbide particles having a D50 of greater than 12 μm and a D10 of greater than 5 μm comprising from 9 to 11 weight percent of a metallic binder based on total weight of the sintered cemented carbide particles, wherein the apparent density of the powder composition is from 3.0 g/cm³ to 6.0 g/cm³.

The powder compositions may be used in any suitable additive manufacturing technique to form a three-dimensional part. The term “additive manufacturing technique” refers to processes for forming a three-dimensional object by successively adding material to the object layer by layer. The layer-by-layer, stratified construction makes it possible to easily form undercuts and complex geometrical structures, which, with previous conventional manufacturing methods, was not possible or required considerable effort and expense. The three-dimensional object may be based upon a 3D model of the component object that may be electronically designed as an electronic file having the design parameters. Additive manufacturing may also be referred to as 3D printing. The additive manufacturing technique of the invention comprises a process for forming a ceramic powder into the sintered cemented carbide body.

The additive manufacturing process may comprise, for example, binder jetting. As used herein, “binder jetting” or “binder jet” refers to the following method of producing a component: selectively jetting droplets of liquid binder onto a bed of powder (e.g., a ceramic powder) based on a 3D model of a component, adhering particles into a cross-section, depositing additional powder then binder to form the next layer of the object and repeating this process until the green component is finished. For example, the binder jetting apparatus spreads a layer of the metal, ceramic, or cermet powder in a build box, a printhead moves over the powder layer depositing liquid binder according to design parameters for that layer, the layer is dried, the build box is lowered, a new layer of ceramic powder is spread, and the process is repeated until the green article (body) is completed. Although binder jetting is primarily described herein as the additive manufacturing process for making the present materials, other types of additive processes may be adapted for use herein.

Sintered cemented carbide particles of the powder composition each comprise individual metal carbide grains sintered and bound together by a metallic binder. The sintered cemented carbide particles may have a substantially spherical shape. As used herein, “spherical” means that the particles are generally sphere-shaped, having convexly curved outer surfaces with substantially no flat or concave surface areas, and an aspect ratio of 1:1.

The sintered cemented carbide particles of the powder composition may have a D50 of greater than 12 μm, such as at least 13 μm, such as at least 14 μm. The sintered cemented carbide particles of the powder composition may have a D50 of no more than 20 μm, such as no more than 18 μm, such as no more than 16 μm. The sintered cemented carbide particles of the powder composition may have a D50 of greater than from 12 μm to 20 μm, such as from 13 μm to 18 μm, such as from 14 μm to 16 μm. As used herein, “D50” means the point in the size distribution in which 50 percent or more of the total volume of material in the sample is contained. For example, a D50 of 12 μm means that 50 percent of the particles of the sample have a size smaller than 12 μm.

The sintered cemented carbide particles of the powder composition may have a D10 of at least 5 μm, such as at least 6 μm, such as at least 7 μm. The sintered cemented carbide particles of the powder composition may have a D10 of no more than 10 μm, such as no more than 9 μm. The sintered cemented carbide particles of the powder composition may have a D10 of from 5 μm to 10 μm, such as from 6 μm to 9 μm, such as from 7 μm to 9 μm. As used herein, “D10” means the point in the size distribution in which 10 percent or more of the total volume of material in the sample is contained. For example, a D10 of 5 μm means that 10 percent of the particles of the sample have a size of 5 μm or smaller.

The sintered cemented carbide particles of the powder composition may have a D90 of at least 10 μm, such as at least 15 μm, such as at least 18 μm. The sintered cemented carbide particles of the powder composition may have a D90 of less than 30 μm, such as no more than 25 μm, such as no more than 22 μm. The sintered cemented carbide particles of the powder composition may have a D90 of from 10 μm to less than 30 μm, such as from 15 μm to 25 μm, such as from 18 μm to 22 μm. As used herein, “D90” means the point in the size distribution in which 90 percent or more of the total volume of material in the sample is contained. For example, a D90 of 25 μm means that 90 percent of the particles of the sample have a size smaller than 25 μm.

Powder size distributions described and claimed herein may be measured using a laser diffraction particle size analyzer (S-3500, commercially available from Microtrac MRB). The sintered cemented carbide particles comprise one or more metal carbides. The metal carbides may comprise Group IVB metal carbides, Group VB metal carbides, Group VIB metal carbides, or combinations thereof. For example, the sintered cemented carbide particles may comprise tungsten carbide, chromium carbide, titanium carbide, vanadium carbide, tantalum carbide, niobium carbide, zirconium carbide, and/or hafnium carbide. The sintered cemented carbide particles may comprise tungsten carbide and a second metal carbide. The tungsten carbide may be present in an amount of at least 80 to 85 weight percent based on total weight of the sintered cemented carbide particles. If present, the second metal carbide may be present in an amount of from 0.1 to 5 weight percent based on total weight of the sintered cemented carbide particles.

The sintered cemented carbide particles may not comprise multiple metal and/or non-stoichiometric metal carbides. Double and/or lower metal carbides include but are not limited to, eta phase (Co₃W₃C or Co₆W₆C), W₂C and/or W₃C. Additionally, the sintered cemented carbide particles may exhibit uniform or substantially uniform microstructure.

As previously stated, the sintered cemented carbide particles comprise a metallic binder. The metallic binder may comprise cobalt, cobalt alloys, nickel, nickel alloys, iron, iron alloys, or a combination thereof. The metallic binder may further comprise one or more additives, such as noble metal additives. Examples of noble metal additives that may be used in the present invention include but are not limited to platinum, palladium, rhenium, rhodium, and ruthenium, and alloys thereof. Other additives include molybdenum, silicon, or combinations thereof. If present at all, additives may be present in the metallic binder in an amount of from 0.1 to 10 weight percent of the sintered cemented carbide particles based on total weight of the sintered cemented carbide particles.

The metallic binder may be present in the sintered cemented carbide particles in an amount of at least 9 weight percent based on total weight of the sintered cemented carbide particles, such as 9.1 weight percent, such as 9.5 weight percent. The metallic binder may be present in the sintered cemented carbide particles in an amount of no more than 11 weight percent based on total weight of the sintered cemented carbide particles, such as no more than 10.9 weight percent, such as no more than 10.5 weight percent. The metallic binder may be present in the sintered cemented carbide particles in an amount of from 9 to 11 weight percent based on total weight of the sintered cemented carbide particles, such as from 9.1 to 10.9 weight percent, such as from 9.5 to 10.5 weight percent. The metallic binder may be present in the sintered cemented carbide particles in an amount of 10 weight percent based on total weight of the sintered cemented carbide particles.

The sintered cemented carbide particles may have an average individual particle porosity of at least 2 volume percent, such as 3 volume percent, such as 4 volume percent. The sintered cemented carbide particles may have an average individual particle porosity of less than 20 volume percent, such as less than 17 volume percent, such as less than 15 volume percent, such as less than 10 volume percent, such as less than 5 volume percent. The sintered cemented carbide particles may have an average individual particle porosity of 2 to 20 volume percent, such as 3 to 17 volume percent, such as 4 to 15 volume percent, such as 4 to 10 volume percent, such as 2 to 10 volume percent, such as 2 to 5 volume percent. As used herein, “individual particle porosity” refers to the volume percent of pores in an individual particle based upon the total volume of the particle. That is, if an individual particle has a particle porosity of 20 volume percent, 80 volume percent of the particle comprises material, such as, for example, metal carbides and/or metallic binder.

The powder composition may have an apparent density of at least 3.0 g/cm³, such as at least 3.5 g/cm³, such as at least 4.0 g/cm³. The powder composition may have an apparent density of no more than 6.0 g/cm³, such as no more than 5.5 g/cm³, such as no more than 5.1 g/cm³. The powder composition may have an apparent density of from 3.0 g/cm³ to 6.0 g/cm³, such as from 3.5 g/cm³ to 5.5 g/cm³, such as from 4.0 g/cm³ to 5.1 g/cm³. As used herein, “apparent density” means the mass of a unit volume of powder or particles in the loose condition. Apparent density may also be called bulk density. Apparent density can be determined according to ASTM B212 Standard Test Method for Apparent Density of Free-Flowing Metal Powders using the Hall Flowmeter Funnel.

The powder composition may have a tap density of at least 3.0 g/cm³, such as at least 4.0 g/cm³, such as at least 5.0 g/cm³. The powder composition may have a tap density of no more than 8.0 g/cm³, such as no more than 7.5 g/cm³, such as no more than 7.0 g/cm³. The powder composition may have a tap density of from 3.0 g/cm³ to 8.0 g/cm³, such as from 4.0 g/cm³ to 7.5 g/cm³, such as 5.0 g/cm³ to 7.0 g/cm³. As used herein, “tap density” means the mass of a unit volume of powder once the powder has been tapped for a defined number of taps. Tap density can be determined according to ASTM B527 Standard Test Method for Tap Density of Metal Powders and Compounds.

The ratio of the tap density to the apparent density (Hausner ratio) of the powder composition may be at least 1.10, such as at least 1.20, such as greater than 1.20, such as greater than 1.25. The Hausner ratio of the powder composition may be no more than 1.30, such as no more than 1.29, such as no more than 1.28, such as no more than 1.27. The Hausner ratio of the powder composition may be from 1.10 to 1.30, such as from 1.20 to 1.29, such as greater than 1.20 to 1.28, such as greater than 1.25 to 1.27.

The present invention is further directed to a method of making one of the powder compositions disclosed herein comprising milling the cemented carbide particles with the metallic binder, a polymeric binder, and a solvent to form a mixture; spray drying the mixture to form a powder; sintering the powder; milling and sieving the powder; and sintering the powder for a second time in a partial liquid state to form the powder composition.

The densities and individual particle porosities of the powder compositions disclosed herein can be achieved through one or several sintering processes administered to the particles. The sintering processes may not employ sintering inhibitor(s) to mitigate particle stick or adhesion. Sintered cemented carbide particle properties described herein can be achieved in the absence of sintering inhibitor(s). Sintered cemented carbide particles may be prepared by sintering a grade powder composition at temperatures of from 1100° C. to 1325° C. for from 0.5 to 2 hours to provide a sintered compact. The sintered compact is subsequently milled to provide individual sintered cemented carbide particles. Depending on particle morphology and density, the sintered cemented carbide particles can be further heat treated for further densification. Further heat treatment can include plasma densification, such as plasma spheroidization using an RF plasma torch or DC plasma torch. Alternatively, the sintered cemented carbide particles can be re-sintered forming a second compact. The second compact is milled to provide the sintered cemented carbide particles. Any desired number of additional densification treatments can be administered to provide sintered cemented carbide particles having the desired apparent density, tap density, and/or individual particle density. Sintering times and temperatures can be selected according to several considerations including, but not limited to, binder content of the cemented carbide particles, desired sintered particle density and sintering stage. In some embodiments, early sintering stages are conducted at lower temperatures and/or shorter times to facilitate milling the sintered compact. For example, an initial or early-stage sintering process may be administered at temperatures below binder liquefaction. Late stage or final sintering processes may achieve higher temperatures, such as temperatures at which liquid phase sintering takes place.

The present invention is also directed to a binder jet printed sintered cemented carbide body comprising sintered cemented carbide particles having a D50 of greater than 12 μm and a D10 of greater than 5 μm comprising from 9 to 11 weight percent of a metallic binder based on total weight of the sintered cemented carbide particles, wherein the sintered cemented carbide body has a theoretical density percentage equal to or greater than 99%.

When the carbide comprises tungsten carbide and the metallic binder comprises cobalt, the sintered cemented carbide body may have a vacuum sintered density greater than or equal to 13.75 g/cm³, such as at least 13.8 g/cm³, such as at least 13.9 g/cm³, such as 14.0 g/cm³. The vacuum sintered density may be measured by ASTM B311 Density Determination for Powder Metallurgy Materials containing less than 2% porosity.

When the carbide comprises tungsten carbide and the metallic binder comprises cobalt, the sintered cemented carbide body may have a sintered HIP density equal to or greater than 14 g/cm³, such as at least 14.1 g/cm³, such as at least 14.2 g/cm³, such as at least 14.3 g/cm³, such as about 14.4 g/cm³. The sintered HIP density may be measured by ASTM B311 Density Determination for Powder Metallurgy Materials containing less than 2% porosity.

The sintered cemented carbide body may have a theoretical density percentage of equal to or greater than 99%, such as greater than 99.1%, such as greater than 99.3%, such as greater than 99.5%, such as greater than 99.7%, such as greater than 99.9%. The theoretical density percentage is calculated by dividing the sintered HIP density as measured by ASTM B311 by a reference density. As used herein, “theoretical density” means the maximum achievable density of the sintered cemented carbide body.

The sintered cemented carbide body may have a sinter porosity rating of A02B00C00, A01B00C00, or A00B00C00. The sinter porosity rating may be determined by the procedures of ASTM B276: Standard Test Method for Apparent Porosity in Cemented Carbides Active Only.

The invention is further directed to a method of forming a sintered cemented carbide body comprising: binder jet printing a powder composition comprising sintered cemented carbide particles having a D50 of greater than 12 μm and a D10 of greater than 5 μm comprising from 9 to 11 weight percent of a metallic binder based on total weight of the sintered cemented carbide particles and having an apparent density of from 3.0 g/cm³ to 6.0 g/cm³ and a printing binder to form a green body; and sintering the green body to provide the sintered cemented carbide body. Any of the powder compositions disclosed herein above may be used to form the sintered cemented carbide body.

A green body is formed by binder jet printing one of the power compositions described herein and a printing binder. Any organic binder known in the art may be used as the printing binder. In examples, the organic binder may comprise one or more polymeric materials, such as polyvinylpyrrolidone (PVP), polyethylene glycol (PEG), or mixtures thereof. The organic binder may be curable which can enhance the strength of the green article. The polymeric binder may be an aqueous binder or a solvent binder. The green articles may exhibit a binder saturation of at least 80%, such as 100%, or greater than 100%.

The green body may then be sintered under conditions and for time periods adequate to provide sintered bodies having the desired density. The green article can be vacuum sintered or sintered under a hydrogen or argon atmosphere at temperatures of 1300° C. to 1560° C. Moreover, sintering times can generally range from 10 minutes to 5 hours. Hot isostatic pressing (HIP) may optionally be added to the sintering process. HIP may be administered as a post-sinter operation or during vacuum sintering. Hot isostatic pressing can be administered for up to 2 hours at pressures of 1 MPa to 300 MPa and temperatures of 1300° C. to 1560° C. Microstructures of the sintered cemented carbide bodies may be uniform. The sintered cemented carbide bodies may exhibit a volume shrinkage in the sintered samples compared to as-printed samples of from 60 to 70 volume percent.

Sintered cemented carbide bodies produced according to the methods described herein can be employed in a variety of industries including petrochemical, automotive, aerospace, industrial tooling, metal cutting tools, and manufacturing. The sintered cemented carbide bodies may be used as components exposed to wear environments or abrasive operating conditions such as flow control components, pumps, bearings, valves, valve components, centrifuge components, disk stacks, and/or fluid handling components. The sintered cemented carbide body can also comprise one or more internal fluid flow channels formed by the additive manufacturing technique. The sintered cemented carbide body may be near-net shape and/or require minimal post sintering processing to place the bodies in final form.

### EXAMPLES

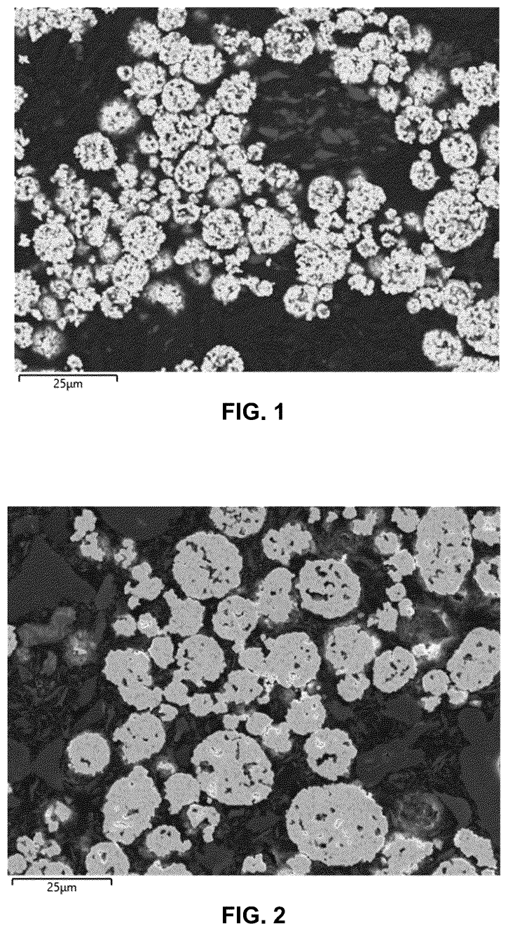

Spherical porous powder (C1) was produced by milling a mixture of 90 wt. % tungsten carbide (WC) particle, 10 wt. % cobalt (Co) powder, and organic additives. Then, the slurry was spray dried and sintered in vacuum (<10-3 torr) in the solid state at 1225° C. to 1275° C. for 1-2 hours, forming lightly sintered powder. The sintered powder was milled and sieved to reach the desired powder size distribution. Spherical dense powder (C2) was produced by re-sintering GUI powder in vacuum (<10-3 torr) in a partial liquid state at 1280° C. to 1330° C. for 1-2 hours to increase the density. The scanning electron microscopy (SEM) images of C1 and C2 cross sections are given in FIGS. 1 and 2, respectively.

Table 1 shows the powder size distribution (D10, D50, and D90), porosity, and shape of C1 and C2 powders. Powder size distribution was measured by laser scattering method using a laser diffraction particle size analyzer (S-3500, commercially available from Microtrac MRB). Powder samples were mounted, polished, and imaged to characterize porosity and morphology. Image processing software, Image J, was applied to the SEM image to compute porosity.

TABLE 1
Properties of powder compositions

| | | | | | Apparent | Tap | | | |
|---|---|---|---|---|---|---|---|---|---|
| | Co | D10 | D50 | D90 | density | density | Hausner | Porosity | |
| Powder | (wt. %) | (μm) | (μm) | (μm) | (g/cm³) | (g/cm³) | Ratio | (%) | Shape |
| C1 | 10.0 | 7.7 | 15.6 | 20.6 | 4.20 | 5.28 | 1.26 | 13 | Spherical |
| C2 | 10.0 | 8.7 | 15.3 | 21.0 | 5.03 | 6.49 | 1.29 | 5 | Spherical |

Test coupons of 25 mm×25 mm×7 mm and 11 mm×11 mm×31 mm were printed from either C1 or C2 using a binder jetting machine “Desktop P1” with a water-based SPJ-04 binder. Binder droplet size on Desktop P1 printer is estimated to be around 20 pL for this specific binder type. The layer thickness was 75 μm and the average binder saturation was in the range of 30% to 60%, as recorded in Table 2.

Test coupons were cured at 195° C. for 4 h in a curing oven in argon atmosphere. After curing, depowdering was performed by removing the surrounding unbounded powder using vacuum. Then samples were put on graphite trays coated with a graphite-based parting agent for debinding and sintering in a sinter-HIP furnace. In the debinding step, samples were heated up to 538° C. in hydrogen atmosphere. In the subsequent sintering step, samples were sintered at a temperature of 1440-1510° C. and a pressure of 3.4-5.5 MPa in argon for 45 minutes. A shrinkage of 60 vol. % to 70% vol. % were observed in the sintered samples compared to as-printed samples. The sintered samples all had a sintered density of 14.4 g/cm³ and a porosity rating of A02B00C00 or lower, adhering to ASTM B276 standard. Results are provided in Table 2.

TABLE 2
Properties of WC—10Co samples.

| | | Binder | Green | Theoretical | Sintered | |
|---|---|---|---|---|---|---|
| | | saturation | density | density | density | |
| Sample | Powder | (%) | (g/cm³) | percentage¹ | (g/cm³) | Porosity |
| 1 | C1 | 30 | 4.83 | 99.7% | 14.38 | (A00)A02B00C00 |
| 2 | C1 | 40 | 4.81 | 99.9% | 14.40 | (A00)A02B00C00 |
| 3 | C1 | 50 | 4.80 | 99.9% | 14.40 | A00B00C00 |
| 4 | C1 | 60 | 4.81 | 99.7% | 14.38 | (A00)A02B00C00 |
| 5 | C2 | 30 | 5.33 | 99.9% | 14.40 | (A00)A02B00C00 |
| 6 | C2 | 40 | 5.34 | 100% | 14.42 | A02B00C00 |
| 7 | C2 | 50 | 5.31 | 100% | 14.42 | (A00)A02B00C00 |
| 8 | C2 | 60 | 5.39 | 100% | 14.41 | (A00)A02B00C00 |

¹Reference density 14.42 g/cm³

As demonstrated by the data provided in Table 2, it has been surprisingly discovered that a high sintered density and excellent porosity rating can be achieved with the powder compositions of the present invention. Significantly, excellent sintering performance was achieved with powder compositions comprising only 10% cobalt by weight based on total weight of the powder composition.

For purposes of this detailed description, it is to be understood that the invention may assume various alternatives and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “from 1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In this application, the use of the singular includes the plural and plural encompasses singular, unless specifically stated otherwise. For example, although reference is made herein to “a” powder composition, “a” cemented carbide body, and “an” apparent density, a combination (i.e., a plurality) of these components may be used.

In addition, in this application, the use of “or” means “and/or” unless specifically stated otherwise, even though “and/or” may be explicitly used in certain instances.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. A method of making a powder composition for binder jet printing comprising:
milling metal carbide particles and a metallic binder to form a slurry;
spray drying the slurry to form a powder;
sintering the powder;
milling and sieving the powder; and
re-sintering the powder in a partial liquid state to form the powder composition, wherein the powder composition comprises cemented carbide particles having a D50 of greater than 12 μm, a D10 of greater than 5 μm, and an apparent density of from 3.0 g/cm³ to 6.0 g/cm³, and comprise from 9 to 11 weight percent of the metallic binder based on total weight of the cemented carbide particles.

2. The method of claim 1, wherein the powder is sintered at a temperature of 1100° C. to 1325° C.

3. The method of claim 1, wherein the powder is sintered for 0.5 to 2 hours.

4. The method of claim 1, wherein the powder is re-sintered at a temperature of less than 1330° C.

5. The method of claim 1, wherein the powder is re-sintered at a temperature of 1280° C. to 1330° C.

6. The method of claim 1, wherein the powder is re-sintered for at least 1 hour.

7. The method of claim 1, wherein the powder is re-sintered for 1 to 2 hours.

8. The method of claim 1, wherein the powder is milled following the re-sintering.

9. The method of claim 1, wherein the cemented carbide particles comprise tungsten carbide and the metallic binder comprises cobalt.

10. The method of claim 1, wherein the cemented carbide particles comprise from 9.5 to 10.5 weight percent of the metallic binder based on total weight of the cemented carbide particles.

11. The method of claim 1, wherein the D50 is at least 14 μm.

12. The method of claim 1, wherein the D50 is from greater than 12 μm to 16 μm.

13. The method of claim 1, wherein the D10 is from greater than 5 μm to 10 μm.

14. The method of claim 1, wherein the D10 is at least 7 μm.

15. The method of claim 1, wherein the cemented carbide particles have a D90 of less than 30 μm.

16. The method of claim 15, wherein the D90 is from 15 μm to 25 μm.

17. The method of claim 1, wherein the cemented carbide particles have a particle porosity of less than 20 volume percent.

18. The method of claim 1, wherein the cemented carbide particles are substantially spherical.

19. The powder composition of claim 1, wherein the powder composition has a tap density of from 3.0 g/cm³ to 6.0 g/cm³.

20. The method of claim 1, wherein the powder composition has a Hausner ratio of greater than 1.20.
